(19) United States
(12) Patent Application Publication
(10) Pub. No.: US 2014/0303806 A1
(43) Pub. Date: Oct. 9, 2014

(54) APPARATUS AND METHODS FOR PROVIDING TAILORED INFORMATION TO VEHICLE USERS BASED ON VEHICLE COMMUNITY INPUT

(71) Applicant: GM GLOBAL TECHNOLOGY OPERATIONS LLC, DETROIT, MI (US)

(72) Inventors: FAN BAI, ANN ARBOR, MI (US); DONALD K. GRIMM, UTICA, MI (US); LEONARD C. NIEMAN, WARREN, MI (US); ROBERT A. HRABAK, WEST BLOOMFIELD, MI (US)

(73) Assignee: GM GLOBAL TECHNOLOGY OPERATIONS LLC, DETROIT, MI (US)

(21) Appl. No.: 13/856,622

(22) Filed: Apr. 4, 2013

(51) Int. Cl. G06F 17/30

(52) U.S. Cl. CPC G06F 17/30241
USPC 701/1; 707/728; 707/727

(57) ABSTRACT

The present disclosure relates to a method, for providing a relevant information set, based on vehicle crowd data, to vehicles. The method includes receiving, from a plurality of participating vehicles, vehicle crowd data relating to a condition sensed by the participating vehicles in a geographic area, yielding received vehicle crowd data. In one embodiment, the condition includes at least one pre-identified condition selected from a group consisting of cruise-control engagement, road hazard, icy road, other slick-road condition, and vehicle-security violation. The method also includes filtering the received vehicle crowd data, yielding relevant vehicle crowd data, and constructing, by the device, using the relevant vehicle crowd data, the relevant information set. The method further includes sending the relevant information set for delivery to one or more user vehicles associated with the geographic area.

### TECHNICAL FIELD

The present disclosure relates generally to systems and methods for providing relevant and useful information to vehicle users and, more particularly, to apparatus and methods for providing the information being based on input from a community of participating vehicle systems.

### BACKGROUND

The ever-increasing automation of modern vehicles is being accompanied by services providing various types of corresponding information to drivers. With the advent of in-vehicle navigation systems, for instance, has come services advising drivers, by way of the systems, of local traffic and weather conditions.

To date, the information provided to drivers is based primarily on data originated by official, e.g., governmental, resources, such as the National Weather Service or state traffic departments.

There is a need for systems and processor for providing more-accurate, -relevant, and -useful information to vehicle users, in any of a variety of formats, as described further below herein.

### SUMMARY

The present disclosure relates to a method, for providing a relevant information set, based on vehicle crowd data, to vehicles. The method includes receiving, by a device having a processor, from a plurality of participating vehicles, vehicle crowd data relating to a condition sensed by the participating vehicles in a geographic area, yielding received vehicle crowd data. In one embodiment, the condition includes at least one pre-identified condition selected from a group consisting of cruise-control engagement, road hazard, icy road, other slick-road condition, and vehicle-security violation. The method also includes filtering, by the device, the received vehicle crowd data, yielding relevant vehicle crowd data, and constructing, by the device, using the relevant vehicle crowd data, the relevant information set. The method also includes sending the relevant information set for delivery to one or more user vehicles associated with the geographic area.

In one embodiment, the filtering includes determining, in connection with each item of received vehicle crowd data received, a relevance level.

In one embodiment, the relevance level is determined based at least in part on historic use of the vehicle from which the item of data was received.

In one embodiment, the operation of constructing the relevant information set includes maintaining a running value corresponding to the condition, and maintaining the running value includes (a) increasing the running value in response to determining that a positive-opinion item of data is received from a vehicle having a relevant relevance level and (b) decreasing the running value in response to determining that a negative-opinion item of data is received from a vehicle having the relevant relevance level.

In one embodiment, maintaining the running value includes applying a time-decaying-opinion-intensity function, whereby, in addition to increasing and decreasing the running value based on any positive and negative opinions, the running value is decreased with time at a rate of a pre-determined decay speed.

In one embodiment, a participating vehicle is associated with the geographic area if the vehicle has a characteristic selected from a group consisting of (A) being positioned in the geographic area, (B) being positioned near the geographic area, and (C) being expected to pass through or near the geographic area.

In one embodiment, at least some of the received vehicle crowd data is received with ancillary data selected from a group consisting of (i) a location associated with the condition sensed, (ii) a type of vehicle-security breach, data received from a non-reporting-vehicle third-party device, and (iii) historical data. The ancillary data is used in constructing the relevant information set.

In one embodiment, the device includes a customer-service-center computing device and the vehicle includes an onboard system configured to communicate with the computing device using a proprietary protocol also used by the computing device.

In one embodiment, the relevant information set is constructed to have at least one characteristic selected from a group consisting of (I) including a heat map identifying the condition, (II) being configured for use in rendering the heat map, (III) including an item-indicating map identifying the condition, (IV) being configured for use in rendering the item-indicating map, (V) including a birds-eye view identifying the condition, (VI) being configured for use in rendering the birds-eye view, (VII) including perspective view identifying the condition, (VIII) being configured for use in rendering the perspective view, (IX) having a message for textual presentation, (X) having a message for audible presentation, and (XI) having an indication presentable haptically.

In one embodiment, the filtering is performed according to one of multiple algorithms depending on whether the condition is a sporadic-type condition or a frequent-reporting-type condition.

In one embodiment, the received vehicle crowd data includes at least two of (a) vehicle-specific data, (b) vehicle-sensed environment data, (c) proximate-vehicle data, (d) pass-through data, obtained from a non-reporting-vehicle device, and (e) supporting data including one or more of historic data, user-profile data, vehicle-profile data, and statistics data related to a relevant vicinity.

In one embodiment, sending the relevant information set, for delivery to the one or more user vehicles associated with the geographic area, comprises transmitting the data to a third-party device configured to manipulate the relevant information data set and send the relevant information data set manipulated for receipt by the one or more user vehicles.

In one embodiment, the method further comprises identifying interested vehicles, of a candidate pool of receiving vehicles, sending the relevant information set for delivery to the one or more user vehicles associated with the geographic area includes sending the relevant information set for delivery to the interested vehicles identified, and identifying the interested vehicles, of the candidate pool, depends on at least one of past vehicle activity and user preference.

In another aspect, the present technology includes a method, for providing a relevant information set, based on vehicle crowd data, to vehicles, including receiving, by a device having a processor, from a plurality of participating vehicles, vehicle crowd data relating to a condition sensed by the participating vehicles in a geographic area, yielding received vehicle crowd data. The method also includes filtering, by the device, the received vehicle crowd data, yielding relevant vehicle crowd data, wherein the filtering includes determining, in connection with each item of received vehicle crowd data, a relevance level. The method further includes constructing, by the device, using the relevant vehicle crowd data, the relevant information set, and sending the relevant information set for delivery to one or more user vehicles associated with the geographic area.

In one embodiment of this aspect, determining the relevance level is based at least in part on historic use of the vehicle from which the item of data was received.

In one embodiment of this aspect, the historic use relates to a frequency with which cruise control has been engaged at the vehicle from which the data item was received.

In one embodiment of this aspect, constructing the relevant information set includes maintaining a condition-specific running value, corresponding to the condition, and maintaining the running value comprises (a) increasing the running value in response to determining that a positive-opinion item of data is received from a vehicle having a relevant relevance level, and (b) decreasing the running value in response to determining that a negative-opinion item of data is received from a vehicle having a relevant relevance level.

In one embodiment of this aspect, maintaining the running value includes applying a time-decaying-opinion-intensity function whereby, in addition to increasing and decreasing the running value based on any positive-opinion and negative-opinion items of data, the running value is decreased with time according to a pre-determined decay speed.

In one embodiment of this aspect, the filtering includes determining a severity level of at least some items of vehicle crowd data received, the level relating to a severity of the condition being reported by the item of vehicle crowd data.

In still another aspect, the present technology includes a method, for providing a relevant information set, based on vehicle crowd data, to vehicles, including receiving, by a device having a processor, from a plurality of participating vehicles, vehicle crowd data relating to a condition sensed by the participating vehicles in a geographic area, yielding received vehicle crowd data. The method of this aspect also includes filtering, by the device, the received vehicle crowd data, yielding relevant vehicle crowd data, wherein the filtering includes estimating a value corresponding to the condition according to x(t)^{E}=Bx(t)+(1−B)x(t−T), wherein x(t)^{E} represents the value estimated. B represents a pre-established weighted factor, x(t) represents a present condition level, corresponding to the condition, the received vehicle crowd data, and a present time (t), and x(t+T) represents a recent condition level, corresponding to the condition, and a recent time (t+T) separated from the present time (t) by a separation time (T). Further, the method includes constructing, by the device, using the relevant vehicle crowd data, the relevant information set, and sending the relevant information set for delivery to one or more user vehicles associated with the geographic area.

Other aspects of the present technology will be in part apparent and in part pointed out hereinafter.

### DESCRIPTION OF THE DRAWINGS

FIG. 1 illustrates an environment in which the present technology can be implemented, including a community of vehicles, a remote processing center, and communications infrastructure.

FIG. 2 illustrates schematically an example community vehicle.

FIG. 3 illustrates a method for providing vehicle-crowd-based information to a vehicle user, according to an embodiment of the present disclosure.

FIG. 4 illustrates a first sub-method, of the method of FIG. 3, for collecting relevant data, including vehicle-crowd data.

FIG. 5 illustrates a second sub-method, of the method of FIG. 3, for processing the received data, including performing aggregating and filtering, to produce one or more sets of useful information having desired relevance.

FIG. 6 illustrates a third sub-method, of the method of FIG. 3, for providing the relevant information set to the vehicle user, such as by way of one or more pre-determined renderings at the vehicle.

FIG. 7 illustrates schematically an example filtering sub-routine.

FIG. 8 is a visual representation of a time-decayed running value being affected to positive and negative opinions received over time.

FIG. 9 illustrates an example visual, map-based rendering of the useful information set generated.

FIG. 10 illustrates another example visual rendering of an information set in a heat-map format.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

Descriptions are to be considered broadly, within the spirit of the description. For example, references to connections between any two parts herein are intended to encompass the two parts being connected directly or indirectly to each other. As another example, a single component described herein, such as in connection with one or more functions, is to be interpreted to cover embodiments in which more than one component is used instead to perform the function(s). And vice versa—i.e., multiple components described herein in connection with one or more functions is to be interpreted to cover embodiments in which a single component performs the function(s).

The figures are not necessarily to scale and some features may be exaggerated or minimized, such as to show details of particular components.

In some instances, well-known components, systems, materials or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. OVERVIEW OF THE DISCLOSURE

The present disclosure, thus, in various embodiments describes a framework, including apparatus and methods for constructing, in one more phases or stages, useful information sets based on input from a community of participating vehicle systems, and providing the information to user vehicles.

The framework, or characteristics thereof, can be referred to as a crowd-wisdom framework or characteristics, as the technology harnesses and leverages wisdom afforded by the numerous various data inputs received from the sensing (or, participative sensing) of the participating vehicles constituting the crowd. From one perspective, while data originated at each vehicle data may have some inaccuracy, information sets constructed using such data from numerous vehicles in a crowd, in some instances over time, will be more accurate and reliable indicators of existing conditions.

As provided, in most embodiments, the primary system processing is performed at a remote, or cloud, computing system. A benefit of harnessing crowd wisdom at a remote computing system is that the resource-intense processing involved in creating the information sets or other conclusions that the participating vehicles and users will use to operate the vehicle, is performed at the relatively-resource rich system(s). In this way, the vehicles and their users have access to the helpful information at the vehicle without it having to be generated onboard using valuable vehicle resources.

The information set is constructed, as mentioned, based on data collected or otherwise received from a crowd of participating vehicles, possibly supplemented by data from auxiliary sources such as the national weather service, state-wide traffic departments, or private enterprise. The crowd data generally includes any of a variety of output from on-vehicle sensors and devices.

In various embodiment, the crowd data includes primary items, for instance, vehicle location data, vehicle movement data (e.g., speed, acceleration, deceleration), in-vehicle conditions such as temperature and humidity, extra-vehicle weather conditions such as temperature, humidity, precipitation, road characteristics such as whether and/or to what extent the road is wet, has ice, has pot holes or other defects, whether the cruise control is enabled, or enabled and engaged, a speed of the vehicle, speed of nearby or proximate vehicles, and status of a vehicle-security or other vehicle-monitoring system, such as whether an alert condition has been detected, such as vehicle moved without being started or without authorization (e.g., towed by thief), a missing radio, missing battery, broken window, jarred door or decklid, or the like.

The crowd data can also include ancillary data, supporting or providing further detail about the primary data, such as location of the characteristics (e.g., location of a pothole sensed), a time at which a primary item was sensed (e.g., time during which cruise control was enabled, engaged, disenabled, disengaged).

As described above and further below, each participating vehicle has any of various sensors and devices for detecting, calculating, or otherwise determining these primary and ancillary conditions related to the vehicle and its environment.

The crowd-wisdom-harnessing nature of the present framework takes advantage of the numerous sensors of the participating vehicles. Some modern vehicles include as many as fifty, a hundred, two hundred, or even more relevant sensors.

The data considered in generating the useful information sets in some embodiments also includes past data, such as historical data, and/or any trends or related data that can be derived there from, as described further below.

As also referenced above and in further detail, below, the system (s) of the present technology aggregates and filters the data obtained (e.g., requested and received (i.e., obtaining by pull), or received automatically or regularly (e.g., obtaining by push). With the data obtained, the technology constructs the useful information set for delivery via to a destination such as vehicles and/or to users via their vehicles or other interfaces, such as a mobile communications device.

Generally, the aggregating and filtering is performed to limit, or focus, operations of constructing the desired information set(s) to most relevant data, and in some cases to give relevant data appropriate weight based on one or more applicable algorithms.

The aggregating and filtering in some embodiments includes, e.g., identifying and considering most relevant data based on characteristics such as times at which data items were formed (e.g., when was the pothole sensed), time ranges during which conditions were present or not present (e.g., how long cruise control has been engaged), severity of conditions (e.g., very icy versus slightly icy), the like, and others.

With the relevant data, the useful information sets is constructed or generated. The constructed information set is in some cases specific to a certain area of interest to the vehicle user, such as an area in which the vehicle is in, headed toward, or expected to be in at a future time. Example areas include metropolitan areas, urban areas, city blocks, rural areas, cities, counties, states, national regions, specific locations or environments (e.g., a parking garage), the like, or other.

The information set is constructed and rendered to the vehicle and/or the vehicle user, e.g., driver or passenger, in such a way as to directly benefit the user. The information set could be generated or provided in response to system recognition that the information would be of likely use to the particular vehicle user, such as based on a history of activity by the user or user vehicle, or based on the current estimation of driver distraction or vehicle context.

For instance, a common cruise-control user is more likely to be interested in whether cruise control is being used by relevant other vehicles in the crowd passing through an area in which the vehicle of the user is approaching, whereas a user who rarely or never uses cruise control can be considered less likely to find this information set useful.

In the prior instance (frequent cruise-control user), the information set is provided and rendered, and perhaps with a heightened level of importance, such as by visual, audible, and/or haptic indicators and/or a more-conspicuous type of visual and/or audible indicator. In the latter instance (infrequent cruise control user), the system could be configured (e.g., corresponding algorithm(s)) to not provide the information set, or provide it according to a lower level of importance or in a less-conspicuous manner.

The information set can take any of a variety of useful forms, such as heat map, a birds-eye view, three-dimensional perspective rendering, chart, graph, list, etc. In some implementations, the information set is provided to the destination (e.g., vehicle) in the rendered format to be used by the vehicle or user. In some embodiments, such as by sending information constituting a heat map that will be displayed to the user via an in-vehicle display. In other implementations, the information set includes more-raw data provided to a destination device, such as the vehicle, which uses it to render a different format (e.g., heat map) interpretable by the user or vehicle. In some embodiments, the rendering device renders the final format according to a pre-established protocol and/or user pre-set preferences, for instance.

As described in more detail below, with reference to the figures, the information set constructed and rendered can include different types of intuitive digital map overlays, such as a heat map—a digital map including heat layers, or coded (e.g., color-coded) areas. The sets can notify the user or vehicle about conditions or characteristics such as about the driving conditions in the area, such as, e.g., road conditions (e.g., icy road, pothole), vehicle-theft or vehicle-vandalism information, whether an area is a high- or low-cruise-control-use area, etc.

In some embodiments, the rendered format, whether rendered at a remote server, at the vehicle, or other electronic device, includes an alert, warning, or other message for the vehicle user. An example message is a textual, audible, or haptic indication that the vehicle is approaching an area in which cruise control is or is not presently popular in the area under the conditions.

The message can be based on present data and/or historical data. Example present, or recent vehicle-movement-related data, includes cruise control speed, acceleration, deceleration, etc., data received from vehicles that are in or recently passed the subject area. Example historical vehicle-movement-related data includes historical cruise control, speed, acceleration, deceleration, etc., of vehicles in the area.

These and other features are described further below in connection with the environment and systems illustrated in the first two figures, and the example modes of operation of the third through sixth figures.

### II. EXAMPLE ENVIRONMENT FOR IMPLEMENTATION

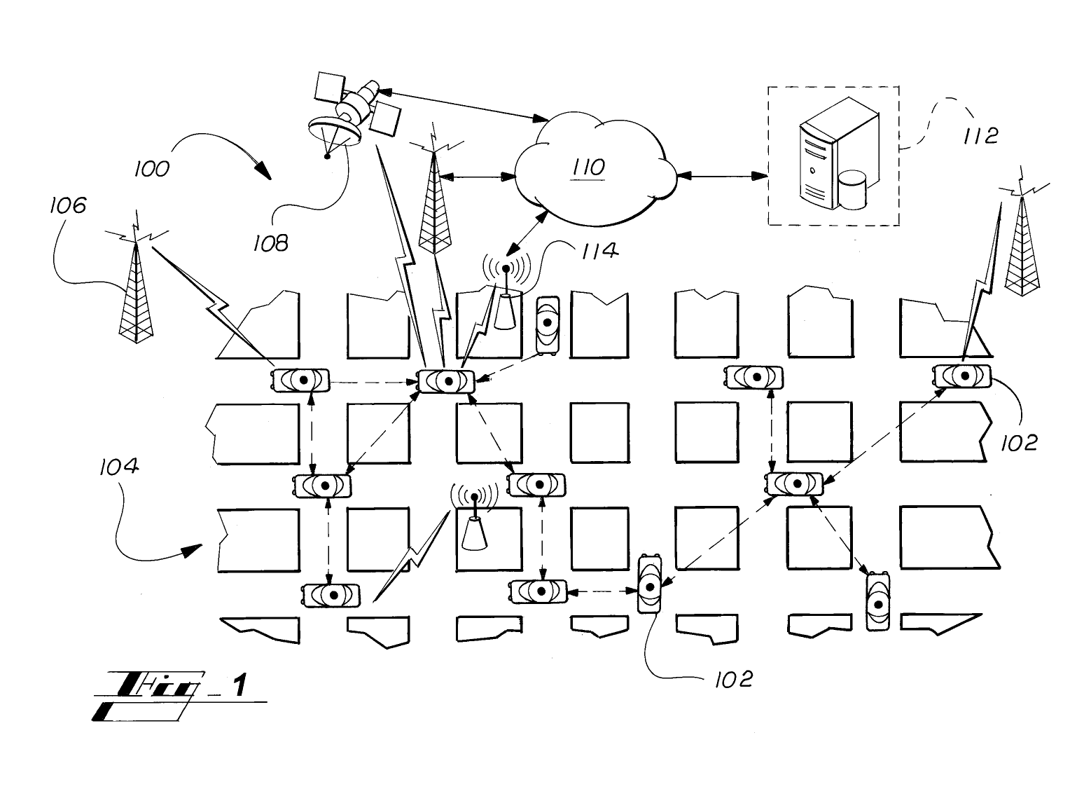

### FIG. 1

Now turning to the figures, and more particularly to the first figure, FIG. 1 illustrates an environment 100 in which the present technology can be implemented.

The environment 100 illustrated includes multiple vehicles 102 shown schematically over a road map 104 (to simplify the figures, as should be appreciated viewing them, not every item (e.g., vehicle, cell tower, satellite, beacons) is illustrated. Each vehicle 102 can be configured to include any of the features described herein.

As described further below, information is received from vehicles, and used to prepare useful reports to one or more vehicles. Vehicles 102 providing the data used in the performance of the present technology can be referred to as participating vehicles. Related system components and operations can be referenced likewise—e.g., the resulting data can be referred to as participative, or crowd, data, aspects of the collection can be referred to as participative sensing, and the like. Participation is based in various embodiments on any of multiple bases, such as the vehicle providing the information, the vehicle 102 being configured with appropriate software for providing the needed information, and/or the vehicle being registered as a participating vehicle, such as by having an OnStar® account.

In some embodiments, the environment 100 of FIG. 1 includes one or more long-range communication nodes, such as cellular base stations 106 or communication satellites 108. The long-range communication nodes are communicatively connected to at least one communication network 110, such as one or more of a cellular telephone network and the Internet.

The environment 100 also includes a remote, central, or cloud, computing system 112, e.g., server, communicatively connected to the communication network 110. In some embodiments, the computer system 112 is a part of a customer service center, such as that associated with OnStar®.

By way of the long-range communication nodes, any of the vehicles 102 configured accordingly, or in-vehicle personal devices such as smart phones, tablets, and laptop computers, can communicate with the central computer system 112 to share data, such as packetized data and voice data.

The environment 100 may also include short-range communication beacons or nodes 114, such as wireless access points (e.g., hot spots). A wireless access point is a transceiver allowing wireless devices such as those of any of the vehicles 102 properly-equipped, or in-vehicle personal devices such as smart phones, tablets, and laptop computers, to connect to the communication network 110.

Short-range communication nodes 114 are commonly positioned in homes, public accommodations (coffee shops, libraries, etc.), and as road-side infrastructure, such as by being mounted adjacent a highway or on a building in a crowded urban area. These communications can be referred to as vehicle-to-infrastructure (V2I) communications. Communications between in-vehicle wireless devices and wireless access points are typically facilitated using IEEE 802.x, WI-FI®, BLUETOOTH®, IRDA, NFC, or related or similar standards. Each vehicle 102 is equipped with components enabling short-range communications.

In some embodiments, some or all of the vehicles 102 are also configured to communicate with each other via short range communications—i.e., vehicle-to-vehicle (V2V) communications. Example V2V communications are indicated in FIG. 1 by dashed lines between vehicles 102. Example V2V communications protocols include those mentioned above, and the dedicated short-range communication (DSRC) protocol.

References herein to short and long-range communications can for various embodiments include what may be known as medium range communications. For instance, what may be referred to as medium range communications, according to a particular communications standard, for instance, may be considered as a short-range communication or a long-range communication. Generally, short-to-medium range communications include communication protocols allowing communication between enabled devices being within about fifty meters, in some cases within about one-hundred meters, and in other cases even within one-thousand meters or more, depending on the communication standard.

Communication functions associated with the vehicles 102 are described further herein below.

### III. COMPUTER SYSTEM

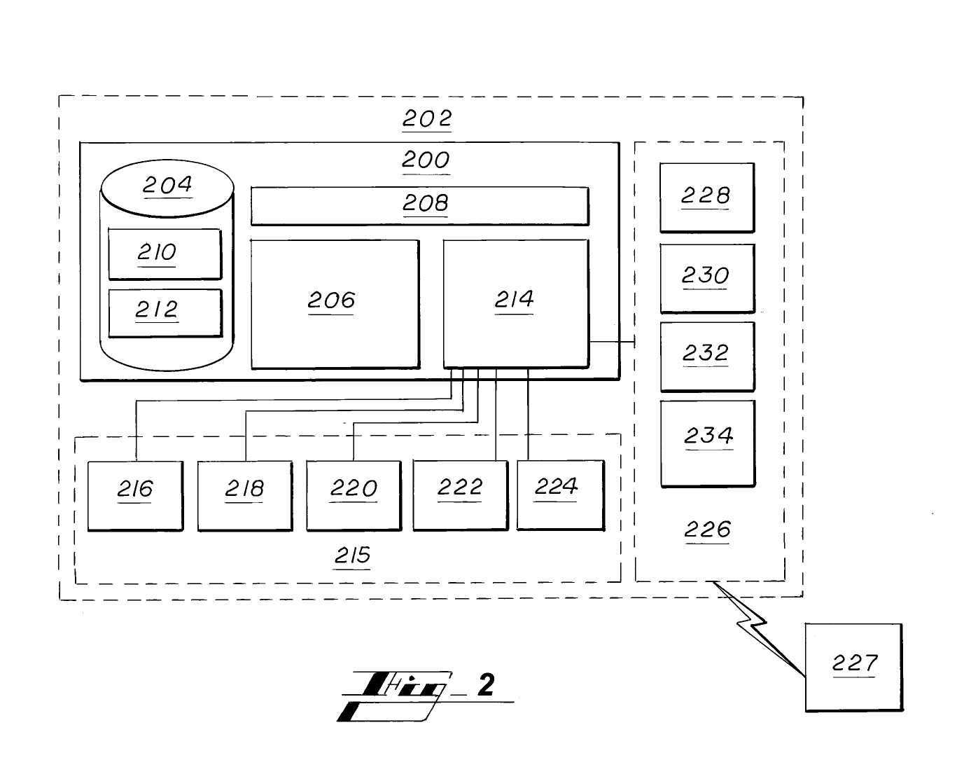

### FIG. 2

FIG. 2 shows an example on-board computer (OBC) 200 for use in any of the vehicles 202 described herein. The OBC 200 includes a computer-readable storage medium, or memory 204 and a processor 206. The processor is in communication with the memory 204 by way of a processor-memory interface 208. An example interface 208 is a data bus. The interface 208 can be wired and/or wireless-based.

The memory 204 stores computer-executable instructions 210 and supporting data 212, in one more modules, executable by the processor 206 to perform the functions of the OBC 200 described herein. The modules can be referenced by the function(s) that its instructions are configured to perform. A module including instructions that, when executed by the processor 206, cause the processor to aggregate data, as described herein, can be referred to as an aggregating module, for instance.

A module having instructions that develop a heat map, advising a user of information of interest, or data to be used at a vehicle for rendering a heat map, can be referred to as a mapping module, rendering module, or the like. The instructions 210 and supporting data are described further below, including in connection with the processes of the present technology.

The OBC 200 also includes a sensor sub-system 215. The sensor sub-system 215 includes sensors providing information to the OBC 200 regarding vehicle operations, vehicle position, vehicle pose, and/or the environment about the vehicle 202. In some embodiments, the sensor sub-system 215 includes one or more object detection sensors, such as a camera 216, long-range detection sensor 218 or a V2X system that detects and communicates with any of a wide variety of communicating objects (roadside wireless access points, etc.).

The camera 216 may include a monocular forward-looking camera, such as those used in lane-departure-warning (LDW) and forward collision alert (FCA) systems. The camera 216 may also include a stereo camera that provides enhanced object range detection. Such sensor sensing external conditions may be oriented in any of a variety of directions without departing from the scope of the present disclosure.

For example, cameras 216 and radar 218 may be oriented at each, or select, positions of, for example: (i) facing forward from a front center point of the vehicle 202, (ii) facing rearward from a rear center point of the vehicle 202, and (iii) facing laterally of the vehicle from a side position of the vehicle 202. Accordingly, the descriptions below, made primarily with respect to forward-facing sensors, may be applied with respect to rearward and/or side facing sensors, independently or in combination with forward-facing sensors.

The range sensor 218 may include, for instance, a short-range radar (SRR), an ultrasonic sensor, a long-range RADAR, such as those used in autonomous-cruise-control (ACC) systems, or a Light Detection And Ranging (LiDAR) sensor, for example.

Other sensor sub-systems include an inertial-momentum unit (IMU) 220, such as one having one or more accelerometers, wheel sensors 222, and other available dynamic vehicle sensors 224, such as a sensor associated with a steering system (e.g., steering wheel) of the vehicle 202.

The OBC 200 also includes a sub-system 226 for communicating with external infrastructure or devices 227. In one embodiment, the sub-system 206 includes or operates in conjunction with an in-vehicle device dedicated to performing functions related to vehicle security, communications, diagnostics, and/or the like, such as the system provided by OnStar®.

This sub-system 226 includes or is in communication with a Global Navigation Satellite System (GNSS) unit 228, having a GNSS receiver, such as a global-positioning system (GPS) unit having a GPS receiver.

In some embodiments, the sub-system 226 includes or is communication with one or more transceivers 230 facilitating long-range wireless communications, such as by way of satellite and cellular telecommunication networks.

The sub-system 226 also includes or in communication with one or more transceivers 230 facilitating short-range wireless communications. The OBC 200 uses short-range communications at least for vehicle-to-vehicle (V2V) communications, vehicle-to-pedestrian communications (V2P), and communicating with transportation system infrastructure (V2I).

The short-range communication transceiver 230 may be configured to communicate by way of one or more short-range communication protocols, such as Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

As referenced below, other systems, such as the remote computer system 112 of FIG. 1, can include a similar architecture (sans the vehicle-specific sensors, for non-vehicle systems).

### IV. METHODS OF OPERATION

### FIGS. 3-6

FIGS. 3-6 show an example method 300 and sub-methods 400, 500, 600, thereof, according to embodiments of the present disclosure. It should be understood that the steps of the methods are not necessarily presented in any particular order and that performance of some or all the steps in an alternative order, including across these figures, is possible and is contemplated.

The steps have been presented in the demonstrated order for ease of description and illustration. Steps can be added, omitted and/or performed simultaneously without departing from the scope of the appended claims. It should also be understood that the illustrated method or sub-methods can be ended at any time.

In certain embodiments, some or all steps of this process, and/or substantially equivalent steps are performed by a processor, e.g., computer processor, executing computer-executable instructions (e.g., instruction 210), corresponding to one or more corresponding algorithms, and associated supporting data (e.g., data 212), stored or included on a computer-readable medium, such as any of the computer-readable memories (e.g., memory 204) described above, including the remote server and vehicles.

While in most embodiments, the device performing the aggregating, filtering, and information-set construction functions of the present technology are performed by a remote computing system, such as the central server 112 of FIG. 2, in some embodiments, one or more of these functions, or aspects thereof, is also or instead performed at one or more other devices, such as one or more of the vehicles. The figures illustrate schematically the algorithms, or the algorithms and steps or operations connecting the algorithms.

IV.A. General Method—FIG. 3

The general method 300 can be divided into three phases or stages, which can also be referred to as sub-methods or sub-processes. The sub-methods include a data collection or gathering sub-method 400, a data aggregation and filtering sub-method 500, and an information set creation and rendering sub-method 600.

The general method 300 thus begins 301 and flow proceeds to the first sub-method 400, wherein data is collected from participating vehicles—e.g., vehicles 102 of FIG. 1. As referenced, above, the data can relate to any of a wide variety of vehicle-related variables, e.g., in-vehicle- or vehicle-environment-related variables. In some aspects, the data is received from a plurality of participating vehicles and can be referred to as crowd data.

In various embodiments, as referenced above, the crowd data includes primary items, for instance, vehicle location data, vehicle movement data (e.g., speed, acceleration, deceleration), in-vehicle conditions such as temperature and humidity, extra-vehicle weather conditions such as temperature, humidity, precipitation, road characteristics such as whether and/or to what extent the road is wet, has ice, has pot holes or other defects, whether the cruise control is enabled or enabled and engaged, and status of a vehicle-security or other vehicle-monitoring system, such as whether an alert condition has been detected, such as a missing radio, missing battery, broken window, jarred door or decklid, or the like.

The crowd data can also include ancillary data, supporting or providing further detail about the primary data, such as location of the characteristics (e.g., location of a pothole sensed), a time at which a primary item was sensed (e.g., time during which cruise control was enabled, engaged, disenabled, disengaged). Data can also be collected from non-vehicle sources, such as a national weather service server.

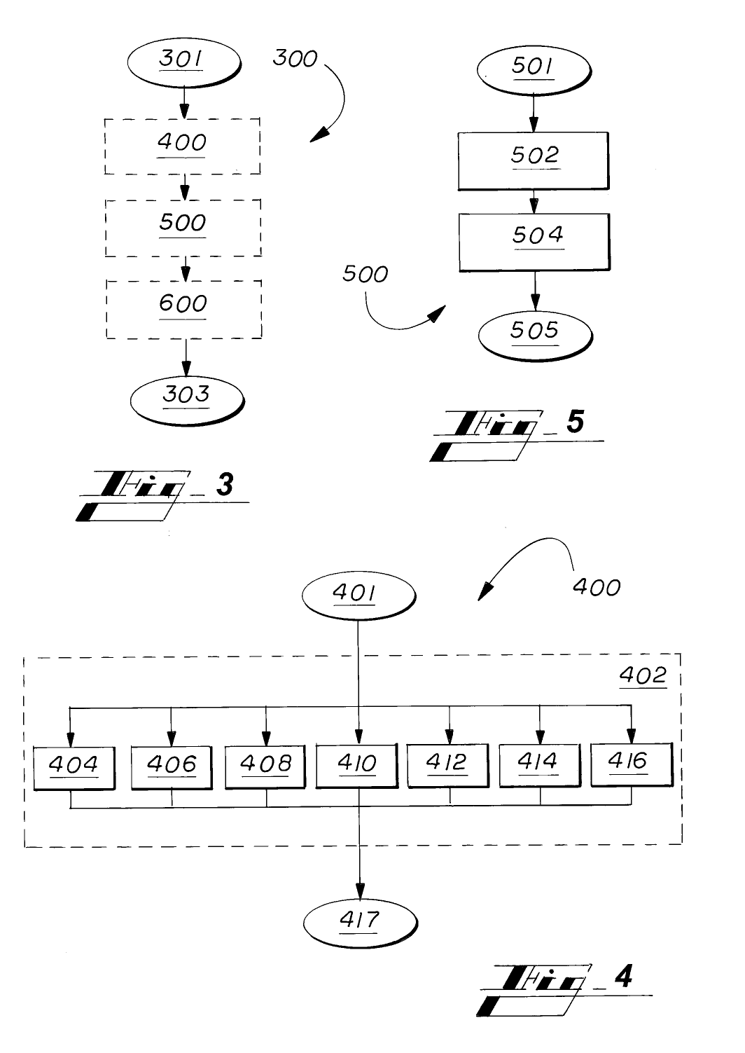

The data collection stage 400 is described in further detail below in connection with FIG. 4. In some embodiments, the data collected in the first stage 400 includes some non-vehicle data (e.g., national-weather-service data) and/or historical data, whether vehicle or non-vehicle data. In some embodiments, some or any of such data is obtained, or accessed (e.g., from pre-storage) as part of the second and/or third sub-methods 500, 600, as described further below in connection with those methods.

From the first sub-method 400, flow of the general method proceeds to the second sub-method 500, wherein the data collected from participating vehicles 102 is aggregated and filtered. In one embodiment, the aggregating includes culling data based on geographic origin of the data. In some embodiments, the filtering is performed to identify most-relevant data, with consideration given to one or more factors such as times associated with data items, characteristics (e.g., past performance) of the users or vehicles from which data is received, a quantitative aspect of the data (e.g., the severity of a pothole encountered), the like, or other. The data aggregation and filtering stage 500 is described in further detail below in connection with FIG. 5.

From the second sub-method 500, flow of the general method proceeds to the third sub-method 600, wherein the data aggregated and filtered is used to create a useful information set. Set generation can also include use of data other than present participative-vehicle-sensed data. As mentioned, while in some embodiments, the data obtained in the first sub-method 400 includes some non-vehicle data (e.g., national-weather-service data) and/or historical data, whether vehicle or non-vehicle data, in other embodiments some or any of such data is obtained in the second sub-method 400.

And, relatedly, in some embodiments, such data is in some implementations obtained prior to aggregating and/or filtering, and so is aggregated or filtered. In some embodiments, such data is pre-aggregated and/or pre-filtered. The data can be, for example pre-compartmentalized, based on features of the data, such as a geographic area associated with the data, a time associated with the data, and stored for ready access for use in the set-creation operations of the third sub-method 600, or in the set-creation operations 600 and any yet-performed aggregation/filtering operations of the second sub-method 500.

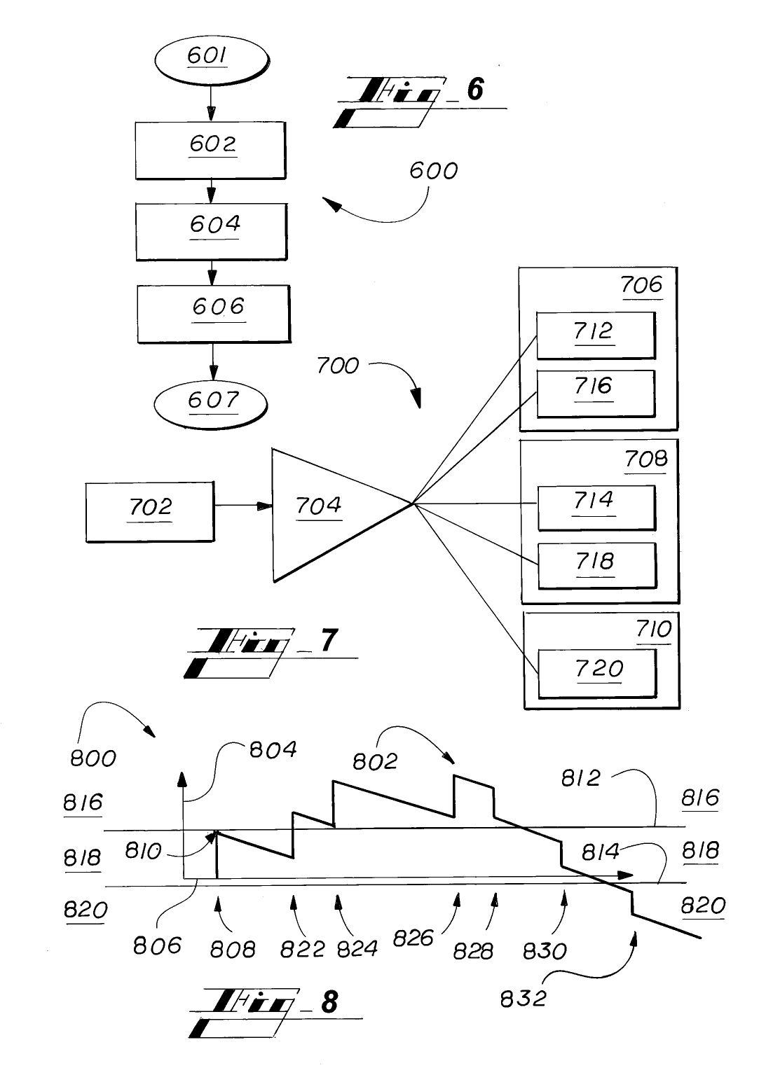

As also referenced, the information set can be generated to have any of a variety of formats, such as a heat map, bird's eye view, a 3D perspective rendering, a list, a graph, a chart, or an alert, notice, or other message, provided textually, audibly, or haptically, for instance. In some implementations, the information set includes data provided to a destination device, such as a server, a mobile device of a user/customer, or a user vehicle, which uses it to render a different format (e.g., heat map) interpretable by the user or vehicle. In some embodiments, the rendering device renders the final format according to a pre-established protocol and/or user pre-set preferences, for instance. The data creation and rendering stage 600 is described in further detail below in connection with FIG. 6.

IV.B. Data Creation and Collection—FIGS. 3 and 4

The first stage or sub-method 400 of the above-referenced general method 300 can be referred to as a participative sensing stage because, in most embodiments, primary data used in performance of the method 300 is in this phase 400 collected from participating vehicles. As mentioned, vehicles 102 providing data used in the performance of the present technology can be referred to as participating vehicles. And the participation is based in various embodiments on any of multiple bases, such as the vehicle providing the information, the vehicle 102 being configured with appropriate software for providing the needed information, and/or the vehicle being registered as a participating vehicle, such as by having an OnStar® account.

The data collected in some cases includes data indicating qualitative participating vehicle parameters and/or sensed events or circumstances, such as whether a certain condition is present, exists, is not present, or does not exist. The data in some instances indicates parameters, events or circumstances qualitatively, such as by an amount, level, pre-set category, or percentage, associated with the parameter, event, circumstance, or condition.

Example qualitative values include a speed of the participating vehicle. Another example is a location of the vehicle, which can be associated with quantitative data—e.g., data indicating that a vehicle theft or other security breach has occurred for the vehicle at the location.

The sub-method of FIG. 4 begins 401, and flow proceeds to block 402, whereat various types of information are collected. The function, or routine, of block 402 can include various operations, performed fully or partially in series or in parallel.

At a primary collection operation 404, vehicle-specific data is obtained (e.g., received by push or pull functions) from one or more participating vehicles (e.g., vehicles 102 of FIG. 1). As provided, the vehicles have numerous sensors or device-state-detecting devices for generating the vehicle-specific data. The sensors or devices include any of those described above in connection with the sensor sub-system 215 of FIG. 2.

The vehicle-specific data can indicate one or more quantitative and/or qualitative vehicle conditions, such as vehicle speed, vehicle acceleration, vehicle deceleration, vehicle location, whether the cruise control is enabled and/or engaged, whether a security condition exists (e.g., the vehicle is being or has been tampered with).

At a second collection operation 406, vehicle-sensed environment data is obtained from one or more participating vehicles. The vehicle-sensed environment data can indicate one or more quantitative and/or qualitative vehicle conditions, such as regarding weather or road conditions. The data can indicate, for instance, that it is raining, or snowing, that the road is wet, icy, or otherwise slick or slippery, has one or more potholes or other road defects, or that an unusual item is in the road, such as a barrier or stalled vehicle.

At a third collection operation 408, proximate-vehicle data is obtained from one or more participating vehicles. The proximate-vehicle data indicates one or more quantitative and/or qualitative vehicle conditions, such as regarding a speed of a nearby vehicle, a location of the vehicle (e.g., relative to the sensing vehicle), an acceleration, deceleration, or lack of acceleration or deceleration of the nearby vehicle, etc.

At a fourth collection operation 410, pass-through data is obtained from one or more extra-vehicle, or non-reporting-vehicle, devices. Pass-through data includes any relevant data received from the vehicle but not sensed at the vehicle. For instance, instead of an acting computing device (e.g., computer center 112) receiving weather data directly from a national weather service server, the system (e.g., the particular participating vehicle 102 and computer center 112, for instance) may be configured so that the computing device receives the weather data from the weather service by way of the vehicle 102.

The vehicle may have already procured, and perhaps used, such data and can pass it along to the computing device alone or with other relevant data. The pass-through information can also include, for instance, data received from nearby communication devices, such as from proximate vehicles (e.g., data indicating a condition (e.g., pothole, or icy road), sensed by the proximate vehicle, a speed of that vehicle, whether that vehicle is using cruise control, etc.), infrastructure (e.g., transportation-system infrastructure (e.g., stop light), businesses, authorities (e.g., fire or police), other entities, etc.

At a fifth collection operation 412, historical data is obtained from one or more sources, such as participating vehicles, the remote server 112, other servers, and/or other sources. The historical data indicates one or more past conditions. The past conditions can include any of the present, real-time conditions referenced above, quantitative and/or qualitative, vehicle-specific or vehicle-environment, etc., such as road conditions, vehicle movement, proximate-vehicle movement, weather, and cruise-control usage.

As referenced above, the historical data is in some embodiments at least partially pre-filtered and stored. The filtering can include, for instance, segmenting the historical data according to a time at which it was received or generated, a location at which it is associated with (e.g., a location of the vehicle that sensed the pothole), and/or other variables. In a contemplated embodiment, the system is configured so that data beyond a certain threshold period of time is discarded.

Regarding time-based categorization, the historical data can be categorized according to the year, month, day, hour, etc., associated with the data.

The manner of categorization can depend on a type of the historical data. For instance, data indicated that a pothole was present on a road months ago, or more, will not likely be relevant to whether there is, or is likely, a pothole on the road now, especially if more-recent corroborating reports have not been received from one or more participating vehicles. As another example, traffic patterns in an area during a certain holiday in a previous year, though, could be indicative of how traffic will flow n the same area during the same holiday in the following year(s). In other words, the system is in some cases configured to filter, store, and/or maintain historical data according to a determined sensitivity of a type of the subject data.

At a seventh collection operation 416, supporting data is obtained (e.g., received by push or pull functions) from one or more sources. In some embodiments, some of the data referenced above, such as the historical data, can be considered supporting data. Other examples of supporting data include data stored at the vehicle 102 or remote server 112, such as at the memory location labeled 112 in FIG. 2 (as referenced above, while FIG. 2 shows, primarily a vehicle, the computing components can also be considered to be instead of a remote computing system, such as that 112 of FIG. 1, to simplify the present disclosure).

The supporting data, where ever stored, in some embodiments includes user-profile information. The profile information may indicate, e.g., how often a user uses cruise control (e.g., enables and/or engages cruise control).

The data can, generally, relate to anything that may be helpful in determining a relevance of other data. For instance, regarding car or car part (e.g., radio) theft, the supporting data can include other information about the relevant vicinity, such as other crime statistics.

At a sixth collection operation 414, any other relevant data is obtained from one or more sources. In some embodiments, the system generates the other relevant data based on other data.

For example, the other data can also include trends identified in the system (e.g., at the vehicle or remote server). For instance, if potholes are increasingly being sensed for the first time in an area, the trend may be stored as a data item. The item can be relevant, for example, in later aggregating, filtering, and/or information-set construction, such as by, in filtering, increasing a likelihood that a new pothole exists in or near the area, such as in a circumstance in which the only actual indication of the new pothole is relatively-slight, such as because only one vehicle reported it, or a vehicle sensor detecting road roughness indicates that the hole was relatively small, qualitatively

The relevant other data is in some implementations considered as supporting data (operation 412), or vice versa.

In some embodiments, the system is configured to collect, and/or otherwise process (e.g., aggregate, filter, or use to construct useful information sets), according to any of various preferred timings. In some embodiments, the timing(s) of data collection(s) is controlled by or otherwise relates to a type or types of data being collected.

Collected data can be divided into two or more of the following classes or groups. While, in describing the groups, vehicle-specific data (e.g., participating-vehicle data) is referenced, primarily, the grouping concept can apply to other types of data, regardless of the source from whence it is obtained.

According to one perspective, all relevant data received can be considered real-time because the data is either, according to the present technology, obtained in real-time, as soon as the corresponding condition is detected (e.g., right after an icy road patch is detected, or a vehicle or vehicle-part theft detected), or reported in a generally regular and very timely manner, such as by being received substantially continuously or periodically with short-intervals (e.g., every minute, every fifteen minutes, every hour, every other hour, etc.). In one embodiment, for most effective real-time data collection based on very-regular, e.g., generally continuous or short-interval, reporting, the vehicles are configured preferably monitor the corresponding conditions (e.g., vehicle speed, vehicle location) in a like, generally continuous or short-interval, manner.

Two of the data types mentioned, short-interval and sporadic data types are now described further. As provided, the short-interval type of data can also be generally continuous—e.g., monitored, sensed at the vehicle, sent to the processing computing system (e.g., server 112), and/or processed at the system continuously.

An example of a data type that can be monitored (and reported, etc.) relatively-frequently monitored by a vehicle (e.g., monitored relatively generally continuously) is vehicle cruise control. Cruise-control monitoring can determine, e.g., whether the vehicle cruise control is engaged—i.e., turned on and activated. Another cruise feature that can be continuously or frequently reported is cruise set speed, being the speed that the vehicle is set to when engaged.

The data types can each be associated with redundancy level, regarding how fast new relevant data of the same type is available at the vehicle. Because the short-interval/continuous data type can change, and be checked, so frequently, it is said to have a quick, or fast, redundancy level.

The data types can each be associated with a likely number of reporters—i.e., the number of participating vehicles that can regularly report the type of data. Because, in at least some embodiments, most or all participating vehicles can monitor and report, there will likely be a relatively large number of short-interval data reportings on an ongoing basis.

The data types can each also be associated with a redundancy level. Because, in at least some embodiments, most or all participating vehicles can monitor and report short-interval data relatively quickly, the redundancy level is high.

Aspects of the other example data type, sporadically or intermittently, are now described. An example of a sporadic or intermittent data type is vehicle theft.

As mentioned, the data types can each be associated with a redundancy level, regarding how fast new relevant data of the same type is available at the vehicle. Because the sporadic or intermittent-type data type is, in some embodiments, reported only occasionally, in response to an event or condition triggering reporting, the data type is said to have a slow redundancy level.

As also mentioned, the data types can each be associated with a likely number of reporters—i.e., the number of participating vehicles that can regularly report the type of data. Because, in at least some embodiments, it is expected that participating vehicles will not often report the sporadic-type data, there will likely be a relatively small number of such data reporting from the vehicles.

Regarding redundancy level, because in at least some embodiments the participating vehicles will only occasionally, in response to an appropriate trigger (e.g., sensing a pothole, or determining that a vehicle part has been stolen), the redundancy level for this type of data is low.

As referenced above, the data can relate to any of a wide variety of vehicle-related variables, e.g., in-vehicle- or vehicle-environment-related variables. In some aspects, the data is received from a plurality of participating vehicles and can be referred to as crowd data. In various embodiments, as referenced above, the crowd data includes primary items, for instance, vehicle location data, vehicle movement data (e.g., speed, acceleration, deceleration), in-vehicle conditions such as temperature and humidity, extra-vehicle weather conditions such as temperature, humidity, precipitation, road characteristics such as whether and/or to what extent the road is wet, has ice, has pot holes or other defects, and whether the cruise control is enabled or enabled and engaged.

Other example data includes that indicating a status of a vehicle-security or other vehicle-monitoring system, such as whether an alert condition has been detected, such as a missing radio, missing battery, broken window, jarred door or decklid, or the like.

In one embodiment, a controller of participating vehicles is in communication with other electrical components of the vehicle and pings, or otherwise communicates with, the components at selected times. The select times may include at each start-up of the vehicle, for instance. The communications serve purposes including ensuring that each component is present and apparently operating properly. Upon detection of a missing or tampered-with component, such as the radio, the controller would initiate reporting corresponding data as part of its participative role in the system. The controller can be, for instance, an electronic control unit (e.g., ECU) or body-control module (BCM) of the vehicle.

In a contemplated embodiment, security or theft-data is initiated by the vehicle user, such as by calling the customer service center (e.g., OnStar® center) to report an incident. Service center personnel and/or automated systems create corresponding incident data based on the user input. In some embodiments, it is not preferred for the system to require such vehicle user input and/or such call-center personnel input, increasing reliance on automated processing.

The crowd data can also include ancillary data, supporting or providing further detail about the primary data, such as location of the characteristics (e.g., location of a pothole sensed), a time at which a primary item was sensed (e.g., time during which cruise control was enabled, engaged, disenabled, disengaged). Data can also be collected from non-vehicle sources, such as a national weather service server.

As provided, in some embodiments, the data collected in the first stage 400 includes some non-vehicle data (e.g., national-weather-service data) and/or historical data, whether vehicle or non-vehicle data. In some embodiments, some or any of such data is obtained, or accessed (e.g., from pre-storage) as part of the second or third sub-methods 500, 600, as described further below in connection with those methods.

Following collection of relevant data as described, the sub-method 400 reaches a transition point 417 at which the sub-method ends, at least tentatively, or is repeated, such as in connection with other data being or to be received.

IV.C. Data Aggregation and Filtering—FIGS. 3, 5, 7, and 8

The monitored and collected data from information is intelligently aggregated and filtered according to relevance. While aggregating and filtering can be viewed as a combined operation, and in some embodiments are, they are described separately at places of the present disclosure to emphasize various functions therein. In some implementations, the aggregating functions are considered a part of the first-phase collection activities 400.

Following the first stage or sub-method 400, FIG. 3 shows the second 500. FIG. 5 shows the sub-method 500 further, wherein after method commencement 501, flow proceeds to block 502, whereat data aggregating is performed Generally, the aggregating 502 includes any other pre-processing that can be viewed as distinct from the subsequent filtering functions. The acts 502 performed can include any off various functions such as grouping, culling, amassing, organizing, and segmenting the received data in an intelligent manner.

In a contemplated embodiment, the aggregating 502 includes segmenting the data received. The segmenting can also be referred to as grouping, organizing, etc., or these terms can have other meanings. The segmenting can be performed based on one or more macro characteristics, such as a location associated with the data—e.g., a location of the vehicles providing the data. The segmenting act may include sending data to a computing component corresponding to one or more characteristics of the data, such as to a remote center 112 server dedicated to serving a corresponding geographic area.

In one implementation, segmenting is performed based on times associated with the data. Example relevant times include a time at which the data was created (e.g., at the participative vehicle), a time at which the data was transmitted (e.g., from the vehicle), a time at which the data was received, and/or some other time indicated in a packet including the data (e.g., a future time of an expected storm identified in a data packet also having weather-related data received).

From any aggregating 502 performed, flow of the algorithm(s) proceeds to block 504, whereat the processor(s) performs one or more filtering operations on the data. Generally, filtering is performed to identify most-relevant data. The function is performed with consideration given to one or more factors such as times associated with data items, characteristics (e.g., past performance) of the users or vehicles from which data is received, a quantitative aspect of the data (e.g., how severe was the pothole encountered), the like, or other.

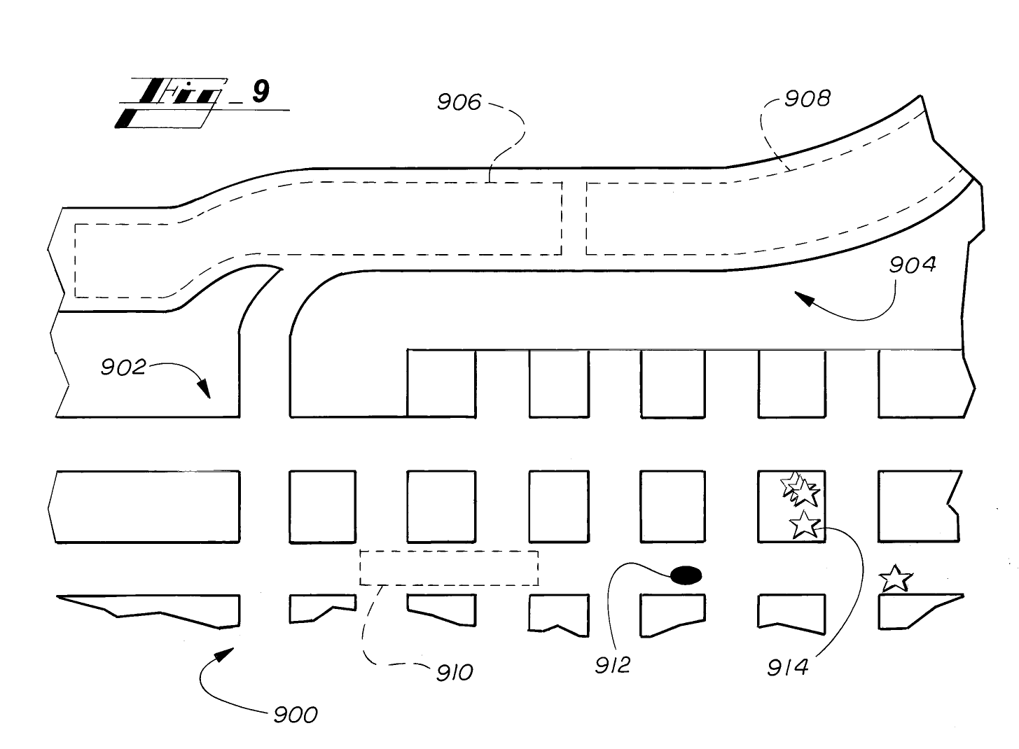

With continued reference to the figures, FIG. 7 illustrates a method showing aspects of a filtering algorithm based on relevance. Input data, or the raw data trace, is represented at left by reference numeral 702. The acting device(s) (e.g., underlying computer-executable instructions or code) is configured to analyze and filter 704 each item of raw data into one of multiple categories.

In one contemplated embodiment, not shown in FIG. 7, the filtering separates the raw data into relevant and non-relevant data. The system discards the data determined irrelevant and proceeds to construct the useful information sets with the relevant data.

In the embodiment illustrated in FIG. 7, the filtering is more detailed, or fine. Namely, the filtering 704 divides the raw data into at least three categories: relevant 706, partially or semi relevant 708, and irrelevant 710. The filtering is performed based on one or more variables. In one embodiment, the filtering is performed primarily based on one or more characteristics, or classifications, associated with the originating vehicle.

As an example, considering the cruise-control genre, each participating vehicles can be characterized as frequent users, less-frequent or infrequent users, and non-cruise-control users (e.g., uses cruise control never or very infrequently) based on an analysis of historic use of cruise control at the vehicle. In this implementation, cruise-control-related data received from a frequent cruise-control-using participating vehicle is filtered 704 to the first, relevant category 706. Likewise, cruise-control-related data received from a less-frequent or infrequent cruise-control-using participating vehicle is filtered 704 to the second, partially-relevant category 708. And data from non-users is filtered 704 to the third, irrelevant category 710.

In one particular implementation regarding the cruise-control-usage genre, the code is configured so that a relevance of raw data received is higher if received from vehicle at which cruise control is frequently enabled. Most cruise control systems have an enabled setting, whereas the cruise feature is turned on or off, and a further engaged, or active, setting, by which the cruise feature is actually activated, in association with a set speed, thereby keeping the vehicle at the set speed. In this implementation, the highest relevance would go to data received from vehicles at which cruise is both frequently enabled and frequently engaged. The code is configured to control whether frequent engagement and frequent enablement have equal weight when both are not the case for a vehicle. In one case, in which they are given equal weight, a next-highest relevance would go to data received from vehicles at which cruise is either frequently engaged or enabled, but not both. And so on.

In one embodiment, the filtering 704 is based at least partially on time. For this, the acting device is configured to filter 704 each item of input data into one of the categories 706, 708, 710 depending on a relevant time associated with the data item. As mentioned above, example relevant times associated with data include a time at which the data was created (e.g., at the participative vehicle), a time at which the data was transmitted (e.g., from the vehicle), a time at which the data was received, and/or some other time indicated in a packet including the data (e.g., a future time of an expected storm identified in a data packet also having weather-related data received).

A data item can also have an associated expiration time and become less relevant (i.e., have less weight) as the data ages and until it expires unless re-detected.

In contemplated embodiments, there are further demarcations of relevance, beyond the three shown 706, 708, 710. The groups filtered 704 to can include, for instance, a highly-relevant group, a relevant group, a less relevant group, and an irrelevant group. Each of these could be further divided—e.g., the highly-relevant group can be divided into very-high relevance and high relevance, etc.

Thus, the filtering 704 can be based on user/vehicle characteristics (e.g., level of historic cruise-control use) or time-related characteristics. The filtering 704 can also be performed based on a combination of these characteristics or another combination including one or both of them and others. An example other characteristics for use in the filtering 704 is geography, or location of the reporting vehicle.

For embodiments in which each participating vehicle is categorized in connection with a genre of activity (e.g., cruise control) based on pre-determined vehicle characteristics related to the genre, categorization of a specific participating vehicle regarding one genre does not necessarily affect categorization of the vehicle regarding other genres. A participating vehicle deemed relevant in connection with cruise-control data filtering would not necessarily be a relevant vehicle in connection with another genre, such as vehicle security or road conditions.

The categorized data is used in constructing the useful information sets. The underlying code is configured such that, effectively, more weight or precedence is afforded data having higher relevance, and less weight or precedence is given less relevant data. In the case of combined considerations—e.g., frequency of cruise-control use and timing both considered in the filtering 704—one of the considerations can act to push relevance of the data up while the other one pushes it up more or pushes it down in relevancy. A resulting relevancy level is thus a hybrid of the constituent relevance characteristics.

With continued reference to FIG. 7, the figures also shows that the filtering 704 can be more fine, grouping each data item, not just according to relevancy levels (e.g., the three levels 706, 708, 710), but also based on a quality of the data. In the example of FIG. 7, the qualitative analysis of the filtering 704 identifies whether incoming raw data 702 includes a positive or negative indication in connection with a genre or aspect of the genre. In one embodiment, the analysis identifies whether raw data is positive 712, 714, neutral 716, 718, or negative 720, 722. If the genre is cruise-control engagement, the raw data can be considered positive 712, 714 if the vehicle cruise control is engaged (i.e., enabled and engaged, or active) and negative 716, 718 if the vehicle cruise control is off (i.e., non-engaged, or non-active).

Thus, the raw data that is received 702 from a participating vehicle at which cruise control is, historically, frequently used and that indicates that the vehicle cruise control is presently engaged would be filtered to the relevant/positive group 712. Raw data that is received 702 from a participating vehicle at which cruise control is, historically, less-frequently used and that indicates that the vehicle cruise control is presently engaged would be filtered to the partially-relevant/positive group 714.

Raw data that is received 702 from a participating vehicle at which cruise control is, historically, frequently used and that indicates that the vehicle cruise control is presently not engaged would be filtered to the relevant/negative group 716. And raw data that is received 702 from a participating vehicle at which cruise control is, historically, less-frequently used and that indicates that the vehicle cruise control is presently not engaged would be filtered to the less-relevant/negative group 718.

In one embodiment, raw data that is received 702 from a participating vehicle at which cruise control is, historically, not used, or used very little, is discarded 720, regardless of whether the data includes a positive or negative indication regarding the condition. In a contemplated embodiment, the positive or negative quality of data received from non-users is kept and considered, but with less weight than higher-relevance data (e.g., data grouped to 712, 714).

Each grouping, however fine, can determine the weight and affect afforded the data item. In some embodiment, a running value or indicator is maintained regarding each genre item (e.g., cruise control usage in a certain area) being evaluated. In particular embodiments in which the five fine groups referenced above, 712, 714, 716, 718, 720, are used, the acting device processes data items from these groups top push the running value or indicator up or down. A first-group item 712 would push the value up the most, a second-group item 714 would push the value up less, a fourth-group item 718 would push the value down the most, and a third-group item 716 would push the value down less.

Fifth-group items would not affect the running value, unless the system was configured to give weight to data from irrelevant data, as mentioned above. In that case, an irrelevant positive data item would push the running value up even less than a second-group item pushes the value up, and an irrelevant negative data item would push the running value down even less than a third-group item would. The same general concept can be applied regardless of the number of relevancy categories used.

As referenced, above, data items of some genres, e.g., regarding negative road conditions (potholes, or icy road) or security conditions, are reported, as a positive instance of the condition, sporadically, in response to a detection of the condition. In these situations, the vehicles are not configured to regularly send negative reports—e.g., a report that the vehicle did not sense a pothole or a security event. In one contemplated embodiment, the acting device (e.g., central server 112 of FIG. 2), in response to receipt of a pre-determined sufficient amount of positive reports regarding a genre (e.g., potholes), determines how many participating passed by the subject area without reporting the pothole. The subject area can be set to various levels of precision, such as to a certain stretch of a street (e.g., a city block), a certain stretch of road or highway, or even a segment of a particular lane of the road or highway.

The device processes the lack of reports to, in one or more ways, effectively lower the corresponding running value. Each non-reporting instance associated with a relevant participating vehicle (e.g., a participating vehicle that passed the subject area recently) can be, for instance, considered as a negative report, placing it in the second or fourth group 716, 718, depending on the relevance level (e.g., first or second level 706, 708) associated with the data.

In another contemplated embodiment, the acting device pings or otherwise requests relevant input from participating vehicles that are relevant (e.g., in the subject area) but did not report a positive data item.

Benefits of the filtering, in addition to identifying more- and less-relevant data, and possibly discarding unreliable or otherwise irrelevant data, include resource savings occasioned by limiting the overall data set. By the filtering 704 in the second stage 500, later processes, in the third, or second and third stage, can be focused on only data categorized at certain relevancy levels, thereby avoiding the latter processing of less relevant or irrelevant data.

FIG. 8 shows a chart 800 including an example running value or indicator 802. The Y-axis 804 represents a confidence, or reliability, of the value. The X-axis 806 represents time. For this example, as can be seen in FIG. 8, all data items are given generally equal weight. This can be because all data items, positive and negative are determined to have the same relevance level (e.g., 706, or 708).

In another interpretation of the data, according to a particular embodiment, only items categorized to the first relevance level 706 are considered (i.e., only positive and negative responses in the first and second sub-groups 712, 716 of FIG. 7) and data items of both the second and third groups 708, 710 are not considered. In this even, either the second group 706 is not present in the algorithm, or items assigned to the group are viewed as neutral data items, or opinions, and so not affecting the running value 802.

In the example 800, the running value 802 is initiated in response to receipt of a first relevant data item, or opinion, at a first time indicated by reference numeral 808. The first data item is positive (e.g., of the first sub-group 712). The first data item is received from a participating vehicle and indicates existence of a certain, usually negative condition, e.g., presence of a pothole on a certain road segment. The running value 802 is created around this genre (e.g., potholes in the subject road segment), and the value is set to a first level 810.

The code can be configured to cause the processing device (e.g., server 112) so that positive and negative data items affect the running value 802 as desired. In the example of FIG. 8, the code is configured to cause the device to in response to a first positive data item to move up but not exceed a first threshold 812. This feature would keep the acting device from constructing an information set and/or reporting the set when there is only slight information supporting the accuracy or likelihood that the reported condition actually exists. The system uses the strength of crowd wisdom in this way, as referenced earlier, above. The concept can also be referred to as consensus building.

It should be appreciated that the chart 800 of FIG. 8 can be considered a simplified visual representation of the running-value processing, and the concepts disclosed can be expanded as needed. For instance, if the subject road was very-frequently traveled, such as a metropolitan highway, the number of relevant data items, be they positive or negative, would be many time more than the few data items illustrated. Effects of this expansion can be appreciated in, for instance, more than one or two positive instances taking the running value above the first threshold, or many more negative instances to pull the value down as shown in the figure.

Returning to FIG. 8, it can be seen that the first and second thresholds 812, 814 define three corresponding chart regions or zones 816, 818, 820, though the code can be configured to include more or less thresholds and more or less regions. The code is configured in some embodiments so that each zone corresponds to an indicator, such as a color or name. Example colors are green for the top zone 816, orange or yellow for the middle zone 818, and red for the lower 820.

In one embodiment, in which the information set to be constructed includes heated map information to be overlaid on a map of the subject geographic area, the zone in which the running value 802 falls controls features of the map overlay. For instance, if a running value 802 for a certain genre (e.g., cruise-control usage) in connection with a first geographic area is in the highest region the first geographic region could be colored green in the heat-map overlay.

If a different running value 802, for the same genre, but a second geographic area, adjacent the first, is in the orange or yellow zone 818, then the heat-map overlay would include an orange or yellow portion for the second geographic area. The same applies to situations and geographic areas for which the running value is in the red zone. As the chart 800 can include more or less than three zones, as described, the heat-map overlays can include more or less than three variations of color.

In a contemplated embodiment, the zone in which the running value 802 falls affects whether an information set is constructed, whether it is sent to vehicles, a quality or type of the set (including or other than the map overlay referenced in the preceding paragraph), a manner by which it is sent (e.g., a priority level of the data transmission including the information set), and/or other.

For example, in one implementation, a type of information set green in this case indicates an affirmative condition under which the acting device should construct and/or send a corresponding information set, and red represents that construction and/or reporting is not needed, or that an information set opposite of the red-zone set is appropriate. The orange, or yellow, zone can correspond to the acting device not constructing and/or sending any information sets, or the device sending an information set of a type that is somehow intermediate the green and red levels, such as by the set indicating that the associated risk or condition is not high or strong, or less likely exists presently.

In another embodiment, the top zone is red and the bottom zone is green, with red indicating that a negative condition exists and should be reported to relevant participating vehicles and green representing that construction and/or reporting is not needed, or that an information set opposite of the red-zone set is appropriate. In another embodiment, the upper level is green because a high running value 802 indicates a positive condition, such as cruise-control presently being used a lot in the corresponding area.

In one embodiment, the acting device determines that information sets for the subject genre should be constructed and provided to participating vehicles in response to the running value 802 being in the highest zone 816. The code can thus be configured so that the acting device is triggered to perform certain actions based on which of the zones 816, 818, 820 the running value 802 has moved into. In one embodiment, for instance, an upper threshold between two higher regions delineates a type of information set constructed and/or sent (or how sent), such as a priority level of the resulting information set (higher priority if the value 802 is in the highest region; lower if in the lower of the two regions), a format of the set (e.g., textual notification, or heat map, on an in-vehicle display along with an audible indicator for the highest region, with perhaps only the textual notification, or heat overlay on an already-displayed navigation map, without the audible aspect, for the lower region).

With continued reference to FIG. 8, following the initial effect on the running value 802 by the first positive data item 808, a time-decaying function is shown. Namely, the code is configured to cause the acting processor to devalue a positive effect of any previous positive data item(s) on the running value 802 according to how much time has passed. The time-decaying function represents a rule whereby the effect of any one or more previous positive affects on the value 802 become less relevant, accurate, or reliable as time passes. As a result, for instance, a positive data item received an hour or a day ago, will have less upward effect on the running value 802 than an otherwise equally-weighted positive value received more recently. As another result, a running value will continue to decrease, moving to consecutively lower zones 816, 818, 820, over time 806 as no corroborating positive data items are received.

This running-value technique can be referred to as one of time-decaying opinion intensity, as the positive and negative data items affect the running value 802 according to a predetermined intensity, which can relate to a relevance category assigned to the data item (e.g., greater intensity of affect on the value 802 by data items of the first positive sub-group 712, and less if of the second positive sub-group 714), and that intensity is devalued, or decayed, over time.

FIG. 8 shows other positive value 802 movements in response to positive data items received at corresponding times 822, 824, 826, and corresponding post-receipt decay for each. The example also includes negative value 802 movements in response to negative data items received at corresponding items 828, 830. 832. As can be seen, the decaying effect acts after negative data items as well.

The slope, or speed, of the decaying effect can be set as desired by a designer of the system.

The decay speed is, in some embodiments, determined by the acting device, and is a function of various factors. Example factors include whether recent data items, or opinions, were positive or negative. For instance, the downward slope of decay can be greater following receipt of a certain number (e.g., 1, 10, 100) of negative opinions within a certain period of time and/or without sufficient (e.g., 1, 10, 100) positive opinions during the time. Another example factor is time since the last relevant data item was received—in one implementation, e.g., the speed of decay is not linear, decreasing more quickly as time goes by without ameliorating, positive, opinion to reset the decay speed at a new running value 802 point.

Other example factors include the genre (e.g., potholes versus cruise-control usage) and type of time of day. As an example regarding genre, the code can be configured so that the speed of decay is controlled by, e.g., proportional to, the frequency at which the data is received for the genre. The decay speed for less-frequent, sporadic, genres (e.g., vehicle or vehicle-part theft) would be lower, and so the effects of a positive data item or opinion would last long and have more effect for a longer time, while the decay speed for more frequent, e.g., generally continuous genres (e.g., cruise-control usage) would be higher.

As another particular example, combining consideration of the genre and time, decay regarding an icy road genre can be linked to how short-term or long-term the particular genre is determined to be.

As another example, again combining consideration of the genre and time, the code can be configured to set the decay slope to be relatively slight during early morning, before the sun comes out, but can become steeper following a time at which the sun comes out, based on historical observations that ice often melts away after that time for this geographic area in this time of year. The same can apply generally, e.g., to evaluations of congestion, whereby the amount of decay is set and changes with consideration given to the fact that traffic is likely to pick up during rush-hour times and subside thereafter.

In one embodiment, negative data items are not considered. In this case, only positive data items, supplemented by the decay effect, are used.

In one embodiment, the underlying code are configured so that the type of genre (e.g., pothole versus cruise-control usage) affects the algorithm used to filter and/or otherwise process the relevant data toward selectively constructing a corresponding information set (e.g., heat map) and/or sending to relevant vehicles. The code can, e.g., call for use of one or more first algorithms in connection with sporadic-type genres (e.g., vehicle security), described above, and for one or more other algorithms for more-frequent or continuous genres (e.g., cruise-control usage).

As mentioned above, the code can be configured to consider times of day, week, or year, such as a timing at which the sun usually appears daily and a melting affect it has on any icy road, or a timing of usual rush hour for the subject day of the week. It should be appreciated that these factors can be pre-set in the code, by a programmer, and or the code can be configured to determine these values based on historical data and trends of the data. In some embodiments, the filtering algorithm is configured so that historical data is considered by the acting device to determine processing rules, or by the programmer programming the rules into the code, in these or in other ways.

One manner of considering past, or historic, data is now described. In this, balanced-philosophy, approach, an appropriate balance between current data and historic data is achieved toward obtaining a more accurate indication of the related condition or phenomenon. The approach also operates to limit, or lower, errors or inaccuracies sometimes (in some cases, often or always to an extent) present in received data. The approach can include any useful curve-smoothing technique. In some implementations, the time-decay approach (or algorithm), described above in connection with FIG. 8, and/or one or more other approaches, is/are used in some situations, such as based on whether a subject phenomenon is more sporadic-type or more continuous-type, and the following, balancing, approach (or algorithm), and/or one or more other approaches, is/are used in the other situations.

In some embodiment, in connection with less-frequent, more-periodic, genres, the algorithm includes a performance prediction function. As a basis for the function, it is appreciated that a given level for a subject feature, or observed phenomenon, (e.g., a likelihood level, a percentage of likelihood, or other indicator, including or different than the running value referenced above) at any given time is, generally, proportionate or otherwise similar to a level that the same feature recently had.

This can be represented as follows: x(t)˜x(t−T), where x(t) represents the level corresponding to the observed phenomenon, or feature, and a given time (e.g., present time), the symbol “˜” represents a close relationship, such as approximately-equal-to or not-likely-much-different-than, and x(t−T) represents the level corresponding to the same feature at a near-term prior time (t−T) (where T is the difference between the present time (t) and the subject recent time (t−T).

The separation-time value T for which the relationship is accurate depends on the subject phenomenon (e.g., genre, and other characteristics being analyzed). The relationship will be true for separation times T up to a relatively-higher maximum in connection with phenomena that tend to change slowly. For more-periodic, slowly-changing, phenomena, the relationship could be true as the separation time T is raised relatively high, such as to a week, a month, 3 months, 6 months, a year, etc., depending on the periodic nature of the phenomena, with higher separation times T possible for slower-, longer-period-, type phenomena.

Conversely, for phenomena that tend to change more quickly, the relationship is accurate only for relatively-lower separation times T. Appropriate separation times T could be, e.g., 1 day, 12 hours, 6 hours, 3 hours, 1 hour, 30 minutes, 15 minutes, 5 minutes, 1 minute, or even a number of seconds, again depending on a frequency of associated with the phenomena, with lower separation-times T being required for fast-changing-type of phenomena.

In a particular embodiment, the performance prediction function, considering this basis, can be represented as follows: x(t)^{E}=Bx(t)+(1−B)x(t−T) [i.e., x(t)^{E}=B·x(t)+(1−B)·x(t−T))], where x(t)^{E} is the estimated level and B is a weighted factor.

The weighted factor B is in some implementations pre-set by a programmer into the code, and in a contemplated embodiment at least partially determined by the acting device executing the code. The factor B, generally, corresponds to a manner by which the subject value being estimated is expected to change during the time T. As can be seen by the equation, with B representing a number between 0 and 1, the estimated value x(t)^{E} will be closer to the most recently measured or determined value x(t) if or when B is greater than 0.5, closer to the previous measured or determined value x(t−T) if or when B is less than 0.5, and an average of the two values x(t) and x(t−T) when B=0.5. Thus, the factor B can be pre-programmed, or determined by the acting device according to pre-programmed rules, to favor the most recent measured or determined value x(t) or the previous x(t−T), or give them equal weight.

The factor in some cases varies based on one or more variables, such as the genre (e.g., high-frequency (e.g., generally continuous) genre, such as cruise-control usage, versus less-frequent or sporadic genre, such as vehicle theft), time (e.g., time of day, time of year), historical data (including, possibly, but not limited to time), the like, and other.

Following the aggregation 502 and filtering 504, the second sub-method 500 reaches a transition point 505 at which the sub-method ends, at least tentatively, or is repeated, such as in connection with other data being or to be received.

IV.D. Information Set Construction—FIGS. 3, 6, 9, and 10

With continued reference to FIG. 3, from the second sub-method 500, flow of the general method proceeds to the third sub-method 600, which is the subject of FIG. 6. In the third sub-method 600, the data aggregated and filtered the second sub-method 500 is used to create a useful information set.

As referenced, set generation can also include use of data other than present participative-vehicle-sensed data. And while in some embodiments the data obtained in the first sub-method 400 includes some non-vehicle data (e.g., national-weather-service data) and/or historical data, whether vehicle or non-vehicle data, in other embodiments some or any of such data is obtained in the second sub-method 400.

And, relatedly, in some embodiments, such data is in some implementations obtained prior to aggregating and/or filtering, and so is aggregated or filtered. In some embodiments, such data is pre-aggregated and/or pre-filtered. The data can be, for example pre-compartmentalized, based on features of the data, such as a geographic area associated with the data, a time associated with the data, and stored for ready access for use in the set-creation operations of the third sub-method 600, or in the set-creation operations 600 and any yet-performed aggregation/filtering operations of the second sub-method 500.

In addition to information-set construction, the third sub-method 600 includes delivery of the set to the destination, such as the vehicle, a vehicle user (e.g., vehicle driver or passenger), or another device used by the user.

The set can be presented, or rendered, to the user in any of a variety of ways, such as via the vehicle or another device, such as a computing device used by the user. In some implementations, the data is delivered in a format that is processed at a receiving device, e.g., vehicle, for use at the device or for appropriate presentation to the user.

In some implementations, the information set includes data provided to a destination device, such as a server, a mobile device of the user, or a user vehicle, which uses it to render a different format (e.g., heat map) interpretable by the user or vehicle. In some embodiments, the rendering device renders the final format according to a pre-established protocol and/or user pre-set preferences, for instance.

For visual-based presentations, e.g., such as heat maps, lists, or textual messages, where ever rendered, the information set rendered can be referred to as visualized, or visualization, data.

In one embodiment, the information-set is delivered to a third-party device (e.g., server), which manipulates the set before presentation to the user vehicle or other user device. The manipulation can include, e.g., incorporation of additional data, or performing specialized functions that the third-party device is specially configured to perform. An example third party is a provider of mapping services. In this case, the information set can include heated map-overlay information and the third-party device can overlay the information over an appropriate map and present the resulting combination to the user device, e.g., vehicle for presentation to the user via the onboard display.

In one embodiment, manipulating or rendering is performed at the vehicle at least in part by third-party software. The software in this case is referred to as third-party software because it is provided by and/or proprietary to an entity (third-party software developer) differing from a primary entity, such as a vehicle original equipment manufacturer (OEM) or an OEM with respect to primary software (e.g., software of OnStar) used primarily in the method 300.

Various financial relationships can be created between third-party providers and the applicable OEM(s). For instance, OnStar can pay a mapping-services provider according to an agreeable fee structure for performance of the third-party services.

With reference to FIG. 6, the sub-method 600 begins 601 and flow proceeds to block 602 where aggregated and/or filtered data is obtained (e.g., received by push or pull mechanism).

Flow of the algorithm 600 proceeds to block 604 whereat the processor of the acting device, executing the computer-executable instructions, begins constructing an appropriate information set. Constructing the information set in some implementations includes consideration of historical data, user preferences, and/or information from remote sources, such as the national weather service.

As referenced, the information set can be generated to have any of a variety of formats, such as a heat map, a list, a graph, a chart, or an alert, notice, or other message, provided textually or audibly, for instance. Regarding messages, the text or voice message can advise, for instance, “cruise-control usage is high for ten miles starting in one-half mile,” or other appropriate message depending on the genre or circumstances. As another example, if a user is pulling over to park the vehicle, the message may advice, “multiple vehicle invasions have been reported in this area within recent months.”

Whatever the form, the information set can advise the vehicle and/or vehicle user of conditions related to phenomena, or genres, such as those related to weather—e.g., icy road, wet road, slick or slippery road, high wind, hail, fog, heavy rain, severe weather (tornado, storm, hurricane, etc.), the like, or other. Other example phenomena or genres include those related to vehicle security, such as regarding vehicle break-ins, vehicle-part theft, and/or vehicle-contents theft (e.g., stolen purse reported). Some relate to non-weather extra-vehicle conditions, such as pothole, in-road barriers (e.g., police or construction closure of a lane), etc. Some relate to macro, or crowd, vehicle performance, such as cruise-control usage, vehicle speeds/congestion, the like, or other.

Regarding heat maps and the vehicle-content theft genre, for instance, a vehicle-content-theft heat map information set constructed indicates whether a particular region is safe enough to park the car on the street. In some embodiments, the information set is configured, at the constructing device (e.g., server 112), or in rendering, such as at the vehicle or third-party server, to include detail in addition to the basic indication of a condition in connection with the subject area. The information can include, for instance, a time at which the condition (e.g., vehicle-content theft) was occasioned, a type of security breach reported (e.g., vehicle internal part stolen, vehicle radio stolen, vehicle window broken, door jarred, the like, or other).

As another example, regarding heat maps and cruise-control usage, a cruise-advisory heat map constructed can communicate, such as by color codes, whether a particular road segment is currently favorable for cruise control usage.

Updating information sets can be provided at a pre-determined or instantly-determined frequency. A cruise-control heat map can be updated, e.g., every pre-determined period applicable to this type of information set, such as at a pre-set frequency of every ten minutes, every thirty, minutes, etc. Or updates can be sent to the vehicle or other user device at a frequency determined by the acting device based on circumstances, such as a corresponding running value 802, a number of relevant participating vehicles reporting on the phenomenon, user preference (stored, e.g., in storage location 112 of FIG. 2), system preferences (stored in a similar ancillary memory location of the server 112, for instance), and/or other. In one embodiment, the frequency, whether pre-stored or set in-real time, the frequency can also relate to the particular phenomenon or genre. The frequency can, for example, be lower for more sporadic-type phenomena, and vice versa.

As described above the information set is in some cases constructed and rendered to the vehicle and/or the vehicle user, e.g., driver or passenger, in such a way as to directly benefit the user. The information set could be generated or provided in response to system recognition that the information would be of likely use to the particular vehicle user, such as based on a history of activity by the user or user vehicle.

For instance, a common cruise-control user is more likely to be interested in whether cruise control is being used by relevant other vehicles in the crowd passing through an area in which the vehicle of the user is approaching, whereas a user who rarely or never uses cruise control can be considered less likely to find this information set useful.

In the prior instance (frequent cruise-control user), the information set is provided and rendered, and perhaps with a heightened level of importance, such as by visual and audible indicators and/or a more-conspicuous type of visual and/or audible indicator. In the latter instance (infrequent cruise control user), the system could be configured (e.g., corresponding algorithm(s)) to not provide the information set, or provide it according to a lower level of importance or in a less-conspicuous manner.

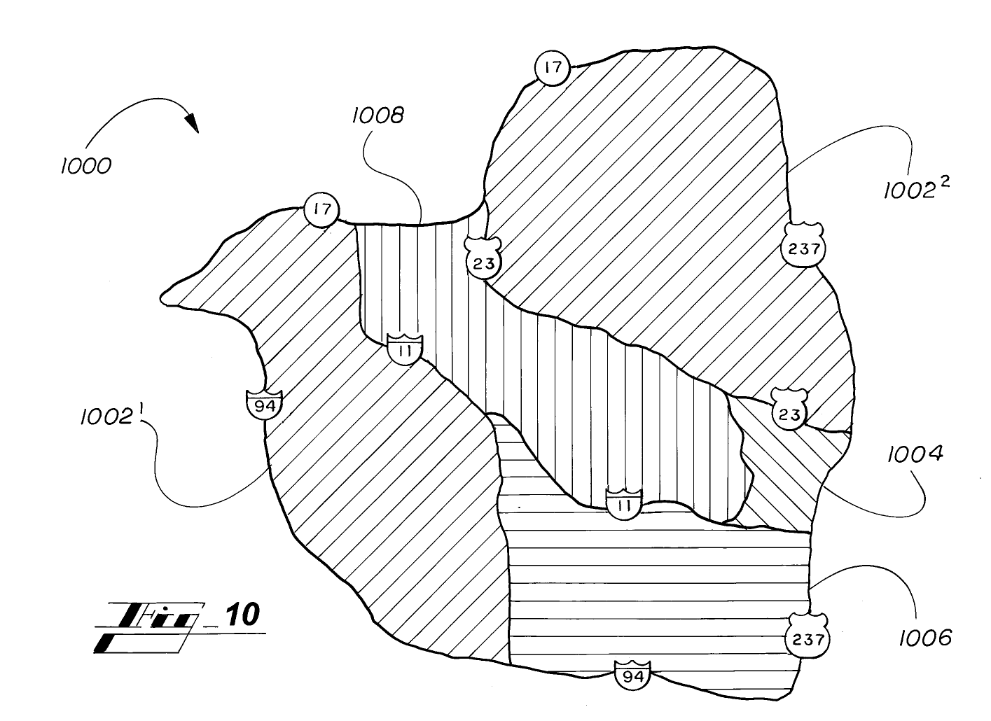

With further reference to the figures, FIG. 9 shows an example visualized information set, or visualization of the information set. The set or visualization includes a map 900. The map includes roads 902 and a highway 904.

A first example indication of a condition of which the user viewing the map is notified is a first cruise-control indication 906. This first indication 906 can indicate to the driver, such as by being presented in a red color, that cruise control is not being used, or not being used heavily in vehicles passing through the area 906 recently.

As described above, the color for the particular area 906 can correspond to a level or grouping identified for the data in the filtering process, such as the red color corresponding to a red label of the lowest group of FIG. 8, based on the running value 802 falling in the lowest zone 820. The display can also include text (not shown) describing the condition (e.g., “high cruise-use area”) or details about the condition (e.g., “average cruise speed: 55 mpg”).

A second example indication of a condition of which the user viewing the map is notified is a second cruise-control indication 908. This second indication 908 can indicate to the driver, such as by being presented in a green color, that cruise control is being used heavily by vehicles passing through the area 908 recently. Again, the color for the particular area 908 can correspond to a level or grouping identified for the data in the filtering process, such as the green color corresponding to a green label of the highest group of FIG. 8, based on the running value 802 falling in the highest zone 816. Again, the display can also include text (not shown) describing the condition (e.g., “low cruise-use area” or “cruise not being used”) or details about the condition.

A third example indication of a condition of which the user viewing the map is notified is a first road warning 910. The road warning 910 can be, for instance, an icy road warning, a slick or slippery-road warning, etc. The warning 910 can include a color and/or pattern indicating what the condition is (e.g., dark blue with reflecting lines for ice, light blue and spots or drops for wet or slipper road), a severity of the warning (e.g., red for high risk, orange for medium, and yellow for low), the like, or other.

A fourth example indication, being a second example road warning, is indicated by reference numeral 912. The second road warning 912 can be, for instance, a pothole or other road hazard. Again, the warning 912 can include a color and/or pattern indicating what the condition is (e.g., black for pothole, orange for construction or other temporary barrier, etc.), a severity of the warning (e.g., red for high risk, orange for medium, and yellow for low), the like, or other.

A fifth example indication of a condition of which the user viewing the map is notified is a vehicle-security notification 914. The security warning 914 is shown shaped as a star, but can include any shape, and can have any color corresponding to a security event, such as red.

Color, shape, pattern, and/or other can also be used to indicate a quality of the incident, such as red for more serious events (e.g., stolen vehicle), orange for medium (e.g., vehicle radio taken), or yellow for low (e.g., wallet taken from unlocked vehicle or through open window). And, again, the display can also include text (not shown) describing each incident, such as “vehicle-part theft,” vehicle window broken,” a time of the corresponding security breach, the like, or other.

With further reference to the figures and, more particularly, to the last figures, FIG. 10 shows a heat-map rendering 1000 of an information set. As described, such a heat-map, or other renderings, can be prepared at a remote central server (e.g., server 112) and sent to the vehicle where the rendering is displayed and/or otherwise provided to the user with no or little manipulation, or can be sent in a pre-final form to the vehicle whereat the information set is manipulated resulting in the final rendering, such as the heat map 1000 of FIG. 10, or sent to a third-party (e.g., map-services server), which in turn sends the final version or a pre-final version to the vehicle.

Maps such as that of FIG. 10 are referred to as a heat map because it includes a map overlaid with colors and/or patterns, being the so-called heats, corresponding to varying conditions in respective areas of the map. In the example of FIG. 10, the overlay includes a first region 1000¹ corresponding to a first condition. The overlay also includes a second region 1000² also corresponding to the first condition.

Because both regions 1000¹, 1000² correspond to the same condition, they would be visualized in the same way, such as by the same color and/or texture or pattern. The color can relate to a quality of the condition, such as by green indicating a positive condition.

If the map 1000 relates to cruise-control usage, for instance, then the first and second regions 1000¹, 1000² can indicate that cruise-control usage is high on the highways in the region, and the color can be green corresponding to the same.

The overlay also includes a third region, 1002. The third region 1002 can be marked by a color different than a color of the first two regions 1000 and/or a different pattern than that of the first two regions 1000. The third region 1002 can be yellow, for instance, to indicate that cruise-control usage is at a medium level, and a fourth region 1004 can be orange to indicate that cruise usage is low in the region 1004. A forth region 1008 can be red to indicate a very-low, or nil usage of cruise control by participating vehicles passing recently through the region.

And as described above, including in connection with FIG. 9, in the heat-map example 1000, the coloring can again can correspond to levels or groupings identified for the related data in the filtering process, such as the green color corresponding to a green label of the highest group of FIG. 8, based on the respective running value 802, or estimated value, falling in the highest zone 816 (e.g., high cruise-control usage), and so on, or red corresponding to the respective running value 802, or estimated value, falling in highest zone 816 (e.g., icy roads), and so on.

At block 606, the information set (or, the relevant information set, post aggregating/filtering), is send for delivery to the user(s) and/or user vehicle(s). As provided, the set can be delivered to the user via a non-vehicle device, such as a mobile phone, tables, or desktop computer.

In one embodiment, the relevant information set is sent for delivery to at least one user vehicle, or otherwise to the user, wherein each user vehicle is associated with the geographic area. In one embodiment, the acting device (e.g., remote server of OnStar®) determines which vehicles are associated with the geographic area. In one embodiment, vehicles self identify to the acting device as being associated with the geographic area. The user vehicle can be associated with the geographic area in one or more of various ways, such as by being positioned in the geographic area, being positioned adjacent or otherwise near the geographic area, having passed near or through the geographic area in the past (e.g., recent past), and being expected to pass (e.g., in near future) though or near the geographic area. Further regarding the latter example, regarding the user vehicle being associated with the geographic area by being expected to pass through or near the geographic area, the user vehicle can be expected to pass through or near the area based, e.g., on any of user vehicle location, direction of travel, a destination entered (e.g., into a navigation system), the like, or other. Regarding references to near, qualification for being near can depend on the circumstances. The qualification can also be programmed by a designer of the system The qualification can be, e.g., that the vehicle is within a block, or two, of the area, within a mile of the area, within five miles, within ten miles, in the same city, metropolitan area, county, state, etc. Similar interpretations can be applied to terms such as, recent past, and near future—e.g., the time length used can be set by a system programmer, and be, e.g., one minute, five minutes, ten minutes, an hour, six hours, twelve hours, a day, a few days, a week, a month, a year, a few years, ten years, or all relevant time—e.g., all time for which data is available.

Following rendering of the information set, or delivery of the information set for rendering, as described, the sub-method 600 reaches a transition point 607 at which the sub-method ends, at least tentatively, or is repeated, such as in connection with other data being or to be received.

### V. BENEFITS

Some of the benefits of the present technology are as follows.

The technology allows for exploitation of crowd wisdom, such as to identify particular driving-related events that may match up with interests of a driver or passenger of a receiving vehicle.

The technology in some embodiments also allows for provisioning of guidance or other assistive information to drivers or passengers based on current and/or historic data, such as map overlay data.

The technology in some embodiments generates accurate data based on the aggregation of real-time vehicle trace data results.

Generating useful information sets primarily at a remote, or cloud, device is an efficient use of resources, leaving little associated processing to be performed at participating vehicles.

### VI. CONCLUSION

Various embodiments of the present disclosure are disclosed herein. The disclosed embodiments are merely examples that may be embodied in various and alternative forms, and combinations thereof.

The law does not require and it is economically prohibitive to illustrate and teach every possible embodiment of the present technology. Hence, the above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

1. A customer-service-center system, method, for providing a relevant information set, based on vehicle crowd data, to vehicles, the method comprising:
a processor; and
a non-transitory computer-readable storage device comprising computer-executable instructions that, when executed by the processor, cause the processor to perform operations, for providing a constructed information set, based on vehicle crowd data, to vehicles, comprising:
receiving, from a plurality of participating vehicles, vehicle crowd data relating to a condition sensed by the participating vehicles in a geographic area, yielding received vehicle crowd data, wherein the condition includes at least one pre-identified condition selected from a group consisting of:
cruise-control engagement;
road hazard;
icy road;
other slick-road condition; and
vehicle-security violation;
filtering the received vehicle crowd data, yielding filtered vehicle crowd data;
constructing, using the filtered vehicle crowd data, the constructed information set; and
sending the constructed information set for delivery to one or more user vehicles associated with the geographic area.

2. The method of claim 1, wherein the filtering includes determining, in connection with each item of received vehicle crowd data received, a relevance level.

3. The method of claim 2, wherein the relevance level is determined based at least in part on historic use of the vehicle from which the item of data was received.

4. The method of claim 2, wherein constructing the constructed information set includes maintaining a running value corresponding to the condition, and maintaining the running value comprises:
increasing the running value in response to determining that a positive-opinion item of data is received from a vehicle having a pre-determined relevance level; and
decreasing the running value in response to determining that a negative-opinion item of data is received from a vehicle having the pre-determined relevance level.

5. The method of claim 4, wherein maintaining the running value includes applying a time-decaying-opinion-intensity function, whereby, in addition to increasing and decreasing the running value based on any positive and negative opinions, the running value is decreased with time at a rate of a pre-determined decay speed.

6. The method of claim 1, wherein a participating vehicle is associated with the geographic area if the vehicle has a characteristic selected from a group consisting of:
being positioned in the geographic area;
being positioned near the geographic area; and
being expected to pass through or near the geographic area.

7. The method of claim 1, wherein:
at least some of the received vehicle crowd data is received with ancillary data selected from a group consisting of:
a location associated with the condition sensed;
a type of vehicle-security breach;
data received from a non-reporting-vehicle third-party device; and
historical data; and
the ancillary data is used in constructing the constructed information set.

8. The method of claim 1, wherein the vehicle includes an onboard system configured to communicate with the computing device using a proprietary protocol also used by the computing device.

9. The method of claim 1, wherein the constructed information set is constructed to have at least one characteristic selected from a group consisting of:
including a heat map identifying the condition;
being configured for use in rendering the heat map;
including an item-indicating map identifying the condition;
being configured for use in rendering the item-indicating map;
including a birds-eye view identifying the condition;
being configured for use in rendering the birds-eye view;
including perspective view identifying the condition;
being configured for use in rendering the perspective view;
having a message for textual presentation;
having a message for audible presentation; and
having an indication presentable haptically.

10. The method of claim 1, wherein the filtering is performed according to one of multiple algorithms depending on whether the condition is a sporadic-type condition or a frequent-reporting-type condition.

11. The method of claim 1, wherein the received vehicle crowd data includes at least two of:
vehicle-specific data;
vehicle-sensed environment data;
proximate-vehicle data;
pass-through data, obtained from a non-reporting-vehicle device; and
supporting data including one or more of historic data, user-profile data, vehicle-profile data, and statistics data related to a pre-determined vicinity.

12. The method of claim 1, wherein sending the constructed information set, for delivery to the one or more user vehicles associated with the geographic area, comprises transmitting the data to a third-party device configured to manipulate the constructed information data set and send the relevant information data set manipulated for receipt by the one or more user vehicles.

13. The method of claim 1, wherein:
the method further comprises identifying interested vehicles, of a candidate pool of receiving vehicles;
sending the constructed information set for delivery to the one or more user vehicles associated with the geographic area includes sending the constructed information set for delivery to the interested vehicles identified; and
identifying the interested vehicles, of the candidate pool, depends on at least one of past vehicle activity and user preference.

14. A customer-service-center system, method, for providing a relevant information set, based on vehicle crowd data, to vehicles, the method comprising:
a processor; and
a non-transitory computer-readable storage device comprising computer-executable instructions that, when executed by the processor, cause the processor to perform operations, for providing a constructed information set, based on vehicle crowd data, to vehicles, comprising:
receiving, from a plurality of participating vehicles, vehicle crowd data relating to a road condition sensed by the participating vehicles in a geographic area, yielding received vehicle crowd data;
filtering the received vehicle crowd data, yielding filtered vehicle crowd data, wherein the filtering includes determining, in connection with each item of received vehicle crowd data, a relevance level;
constructing, using the filtered vehicle crowd data, the constructed information set; and
sending the constructed information set for delivery to one or more user vehicles associated with the geographic area.

15. The method of claim 14, wherein determining the relevance level is based at least in part on historic use of the vehicle from which the item of data was received.

16. The method of claim 15, wherein the historic use relates to a frequency with which cruise control has been engaged at the vehicle from which the data item was received.

17. The method of claim 14, wherein:
constructing the constructed information set includes maintaining a condition-specific running value, corresponding to the condition; and
maintaining the running value comprises:
increasing the running value in response to determining that a positive-opinion item of data is received from a vehicle having a pre-determined relevance level; and
decreasing the running value in response to determining that a negative-opinion item of data is received from a vehicle having a pre-determined relevance level.

18. The method of claim 17, wherein maintaining the running value includes applying a time-decaying-opinion-intensity function whereby, in addition to increasing and decreasing the running value based on any positive-opinion and negative-opinion items of data, the running value is decreased with time according to a pre-determined decay speed.

19. The method of claim 14, wherein the filtering includes determining a severity level of at least some items of vehicle crowd data received, the level relating to a severity of the condition being reported by the item of vehicle crowd data.

20. A customer-service-center system, method, for providing a relevant information set, based on vehicle crowd data, to vehicles, the method comprising:
a processor; and
a non-transitory computer-readable storage device comprising computer-executable instructions that, when executed by the processor, cause the processor to perform operations, for providing a constructed information set, based on vehicle crowd data, to vehicles, comprising:
receiving, from a plurality of participating vehicles, vehicle crowd data relating to a condition sensed by the participating vehicles in a geographic area, yielding received vehicle crowd data;
filtering the received vehicle crowd data, yielding filtered vehicle crowd data, wherein:
the filtering includes estimating a value corresponding to the condition according to:
x(t)^{E}=Bx(t)+(1−B)x(t−T);
x(t)^{E} represents the value estimated;
B represents a pre-established weighted factor;
x(t) represents a present condition level, corresponding to the condition, the received vehicle crowd data, and a present time (t); and
x(t−T) represents a recent condition level, corresponding to the condition, and a recent time (t−T) separated from the present time (t) by a separation time (T);
constructing, using the filtered vehicle crowd data, the constructed information set; and
sending the constructed information set for delivery to one or more user vehicles associated with the geographic area.
